(19) United States
(12) Patent Application Publication
(10) Pub. No.: US 2013/0166846 A1
(43) Pub. Date: Jun. 27, 2013

(54) Hierarchy-aware Replacement Policy

(71) Applicants: Jayesh Gaur, Bangalore (IN); Mainak Chaudhuri, Uttar Pradesh (IN); Sreenivas Subramoney, Bangalore (IN); Nithiyanandan Bashyam, Bangalore (IN); Joseph Nuzman, Haifa (IL)

(72) Inventors: Jayesh Gaur, Bangalore (IN); Mainak Chaudhuri, Uttar Pradesh (IN); Sreenivas Subramoney, Bangalore (IN); Nithiyanandan Bashyam, Bangalore (IN); Joseph Nuzman, Haifa (IL)

(21) Appl. No.: 13/722,607

(22) Filed: Dec. 20, 2012

(30) Foreign Application Priority Data
Dec. 26, 2011 (IN) 3813/DEL/2011

(51) Int. Cl. G06F 12/08

(52) U.S. Cl. CPC G06F 12/0811
USPC 711/122

(57) ABSTRACT

Some implementations disclosed herein provide techniques and arrangements for a hierarchy-aware replacement policy for a last-level cache. A detector may be used to provide the last-level cache with information about blocks in a lower-level cache. For example, the detector may receive a notification identifying a block evicted from the lower-level cache. The notification may include a category associated with the block. The detector may identify a request that caused the block to be filled into the lower-level cache. The detector may determine whether one or more statistics associated with the category satisfy a threshold. In response to determining that the one or more statistics associated with the category satisfy the threshold, the detector may send an indication to the last-level cache that the block is a candidate for eviction from the last-level cache.

### REFERENCE TO RELATED APPLICATION

This application claims priority to India Application No. 3813/DEL/2011, filed Dec. 26, 2011.

### FIELD OF THE INVENTION

Some embodiments of the invention generally relate to the operation of processors. More particularly, some embodiments of the invention relate to a replacement policy for a cache.

### PRIOR ART AND RELATED ART

One or more caches may be associated with a processor. A cache is a type of memory that stores a local copy of data or instructions to enable the data or instructions to be quickly accessed by the processor. The one or more caches may be filled by copying the data or instructions from a storage device (e.g., a disk drive or random access memory). The processor may load the data or instructions much faster from the caches than from the storage device because at least some of the caches may be physically located close to the processor (e.g., on the same integrated chip as the processor). If the processor modifies data in a particular cache, the modified data may be written back to the storage device at a later point in time.

If the processor requests a block (e.g., a block of memory that includes data or instructions) that has been copied into one or more caches, a cache hit occurs and the block may be read from one of the caches. If the processor requests a block that is not in any of the caches, a cache miss occurs and the block may be retrieved from the main memory or the disk device and filled (e.g., copied) into one or more of the caches.

When there are multiple caches, the caches may be hierarchically organized. A cache that is closest to an execution unit may be referred to as a first-level (L1) or a lower-level cache. The execution unit may be a portion of a processor that is capable of executing instructions. A cache that is farthest from the execution unit may be referred to as a last-level cache (LLC). In some implementations, a second-level (L2) cache, also referred to as a mid-level cache (MLC), may be located in between the L1 cache and the LLC, e.g., closer to the execution unit than the LLC but farther from the execution unit than the L1 cache. In some implementations, the LLC may be larger than the L1 cache and/or the L2 cache.

A particular cache may be inclusive or exclusive of other caches. For example, an LLC may be inclusive of an L1 cache. Inclusive means that when particular memory blocks are filled into the L1 cache, the particular memory blocks may also be filled into the LLC. In contrast, an L2 cache may be exclusive of the L1 cache. Exclusive means that when particular memory blocks are filled into the L1 cache, the particular memory blocks may not be filled into the L2 cache. For example, in a processor that has an L1 cache, an L2 cache, and an LLC, the LLC may be inclusive of both the L1 cache and the L2 cache while the L2 cache may be exclusive of the L1 cache.

To make room to store additional blocks (e.g., data or instructions copied from the storage device or the memory device), each cache may have a replacement policy that enables the cache to determine when to evict (e.g., remove) particular blocks from the cache. The replacement policy of an inclusive LLC may evict blocks from the LLC based on information associated with the blocks in the LLC. For example, the LLC may evict blocks according to a replacement policy based on whether or not the blocks have been recently accessed in the LLC and/or how frequently the blocks have been accessed in the LLC. The replacement policy of the LLC may not have information about how frequently or how recently the blocks in lower-level (e.g., L1 or L2) caches are accessed. As a result, the LLC may not evict blocks that are of no immediate use (e.g., the processor is unlikely to request the blocks in the near future) and could therefore be evicted. The LLC may evict blocks that the processor is about to request, causing a cache miss when the request is received, resulting in a delay while the blocks are copied from the storage device or the memory device into the cache.

Thus, a replacement policy for a particular level of a cache hierarchy may be designed based on information (e.g., how frequently, how recently a block is accessed) available at that level of the hierarchy. Such a level-centric replacement policy may lead to degraded cache performance. For example, in a multi-level cache hierarchy, information associated with accesses to a block in an N^{th} level cache may be unavailable for copies of the block that reside in caches that are at higher (e.g., greater than N) levels in the cache hierarchy. As a result, how frequently or how recently a block is accessed at the N^{th} level of the cache hierarchy may not correspond to how frequently or how recently the block is being accessed at other (e.g., greater than N) levels of the cache hierarchy. In addition, a block evicted from a lower-level cache may continue to remain in a higher-level cache even though the block may be a candidate for eviction from the higher-level cache because the higher-level cache may be unaware of the eviction from the lower-level cache.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example framework to identify a subset of blocks evicted from a lower-level cache as candidates for eviction from a last-level cache according to some implementations.

FIG. 2 illustrates an example framework that includes a cache hierarchy according to some implementations.

FIG. 3 illustrates an example framework that includes state transitions for categorized blocks in a lower-level cache according to some implementations.

FIG. 4 illustrates a flow diagram of an example process that includes sending an eviction recommendation to a last-level cache based on eviction information received from a lower-level cache according to some implementations.

FIG. 5 illustrates a flow diagram of an example process that includes updating statistics associated with categories of blocks based on cache fill information received from a lower-level cache according to some implementations.

FIG. 6 illustrates a flow diagram of an example process that includes sending an indication to a last-level cache that a block is a candidate for eviction according to some implementations.

FIG. 7 illustrates a flow diagram of an example process that includes sending an eviction recommendation to a last-level cache according to some implementations.

FIG. 8 illustrates a flow diagram of an example process that includes sending an eviction recommendation associated with a block to a last-level cache according to some implementations.

FIG. 9 illustrates an example framework of a device that includes a detector for identifying eviction candidates according to some implementations.

### DETAILED DESCRIPTION

### Hierarchy-Aware Replacement Policy for a Last-Level Cache

The technologies described herein generally relate to a hierarchy-aware replacement policy for a last-level cache (LLC). When a block is evicted from a lower-level (e.g. first-level (L1) or second-level (L2)) cache a detector may determine whether or not the block is a candidate for eviction from the LLC. For example, the detector may categorize the block into one of multiple categories based on characteristics of the block, such as a type of request that caused the block to be filled into the lower-level cache, how many times the block has been accessed in the lower-level cache, whether or not the block has been modified, and the like. The detector may maintain statistics associated with blocks evicted from the lower-level cache. The statistics may include how many blocks in each category have been evicted from the lower-level cache. Based on the statistics, the detector may determine whether or not a particular block is a candidate for eviction from the LLC. The detector may be implemented in a number of different ways, including hardware logic or logical instructions (e.g., firmware or software).

The detector may send a recommendation to the LLC if the block is determined to be a candidate for eviction from the LLC. In response to receiving the recommendation, the LLC may add the block to a set of eviction candidates. For example, the LLC may set a status associated with the block to “not recently used” (NRU). When the LLC determines that additional blocks are to be filled into the LLC, the LLC may evict one or more blocks, including the block that was recommended for eviction.

The detector may be located in the lower-level cache or the LLC. For example, in a processor with a two-level (e.g., L1 and LLC) cache hierarchy, the detector may be located either in the L1 cache or in the LLC. In a processor with a three-level cache hierarchy (e.g., L1, L2, and LLC), the detector may be located either in the L2 cache or the LLC. In some implementations, it may be advantageous to locate the detector in the lower-level cache rather than the LLC. This is because the detector may receive a notification for every block that is evicted from the lower-level cache but the detector may notify the LLC only when a block is recommended for eviction. Thus, the number of notifications received by the detector may be greater than the number of notifications sent by the detector to the LLC. Expressed another way, the blocks identified as candidates for eviction from the LLC may be a subset of the blocks evicted from the lower-level cache. Because the LLC is typically located farther from an execution unit of the processor than the lower-level cache, notifications may travel farther and take longer to reach the LLC as compared to notifications sent to the lower-level cache. Thus, locating the detector in the lower-level cache may result in fewer notifications travelling the longer distance to the LLC. In contrast, locating the detector in the LLC may result in more notifications being sent to the LLC, causing the notifications to travel farther than if the detector was located in the lower-level cache.

Thus, by analyzing blocks evicted from a lower-level cache (e.g., L1 or L2 cache), a detector may identify a subset of the blocks that may be candidates for eviction from the LLC. This may result in an improvement in terms of instructions retired per cycle (IPC) as compared to a processor that does not include a detector. In one example implementation, the inventors observed an improvement of at least six percent in IPC.

### Identifying Candidates for Eviction in a Last-Level Cache (LLC)

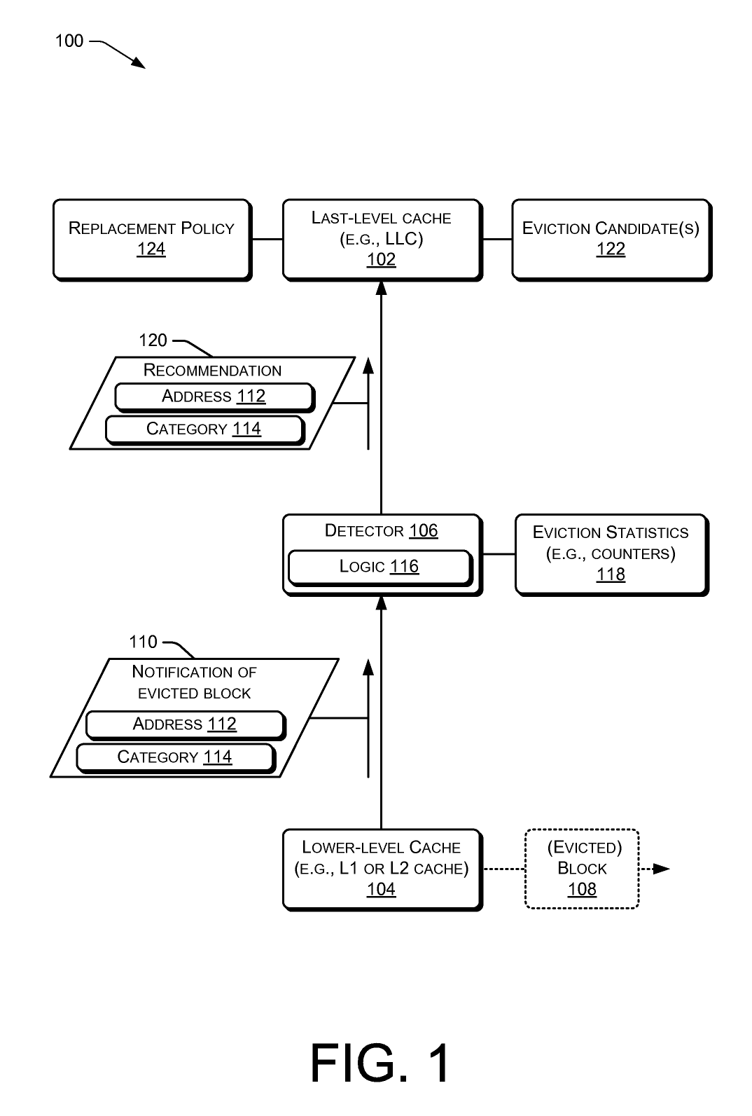

FIG. 1 illustrates an example framework 100 to identify a subset of blocks evicted from a lower-level cache as candidates for eviction from a last-level cache according to some implementations. The framework 100 may include a last-level cache (LLC) 102 that is communicatively coupled to a lower-level (e.g., L1 or L2) cache 104. The framework 100 also includes a detector 106 that is configured to identify eviction candidates in the LLC 102 based on evictions from the lower-level cache 104. Although illustrated separately for discussion purposes, the detector 106 may be located in the lower-level cache 104 or in the LLC 102.

When a block 108 is evicted from the lower-level cache 104, the lower-level cache 104 may send a notification 110 to the detector 106. The notification 110 may include information associated with the block 108 that was evicted, such as an address 112 of the block 108, a category 114 of the block 108, other information associated with the block 108, or any combination thereof. For example, the lower-level cache 104 may associate a particular category (e.g., selected from multiple categories) with the block 108 based on attributes of the block 108, such as a type of request that caused the block 108 to be filled into the lower-level cache 104, how many hits the block 108 has experienced in the lower-level cache 104, whether the block 108 was modified in the lower-level cache 104, other attributes of the block 108, or combinations thereof.

The detector 106 may include logic 116 (e.g., hardware logic or logical instructions). The detector 106 may use the logic 116 to determine eviction statistics 118. For example, the eviction statistics 118 may identify a number of blocks evicted from the lower-level cache 104 for each category, a number of blocks presently located in the lower-level cache 104 for each category, other statistics associated with each category, or any combination thereof. In some implementations, the eviction statistics 118 may include statistics associated with at least some of the multiple categories. The eviction statistics 118 may be updated when a block is filled into the lower-level cache 104 and/or when the block is evicted from the lower-level cache 104. Based on the eviction statistics 118, the detector 106 may identify a subset of the evicted blocks as candidates for eviction from the LLC 102. The detector 106 may send a recommendation 120 to the LLC 102. The recommendation 120 may include the address 112 and the category 114 associated with the block 108. Not all of the blocks evicted from the lower-level cache 104 may be candidates for eviction from the LLC 102. For example, a subset of the blocks evicted from the lower-level cache 104 may be recommended as candidates for eviction from the LLC 102.

In response to receiving the recommendation 120, the LLC 102 may update a set of eviction candidates 122 to include the subset of evicted blocks identified by the detector 106. For example, the LLC 102 may set an identifier (e.g., one or more bits) associated with a particular block to indicate that the particular block is “not recently used” (NRU) thereby including the particular block in the eviction candidates 118. A replacement policy 124 associated with the LLC 102 may evict at least one block from the LLC 102 based on a replacement policy 124. For example, the replacement policy 124 may evict a particular block when the associated identifier indicates that the block is an NRU block.

Thus, the detector 106 may receive a notification 110 from the lower-level cache 104 and determine which of the blocks evicted from the lower-level cache 104 may be candidates for eviction from the LLC 102. The blocks may be evicted from the lower-level cache 104 based on how recently the blocks were accessed, how frequently the blocks were accessed, whether or not the blocks were modified, other block-related information, or any combination thereof. For example, blocks may be evicted from the lower-level cache 104 if they have been accessed less than a predetermined number of times, if they have not been accessed for a length of time that is greater than a predetermined interval, and the like. The detector 106 may send the recommendation 120 to the LLC 102 to enable the replacement policy 124 associated with the LLC 102 to include the evicted blocks identified by the detector in the set of eviction candidates 118. The replacement policy 124 can thus take into account blocks evicted from the lower-level cache 104 when identifying candidates for eviction from the LLC 102.

### Cache Hierarchy

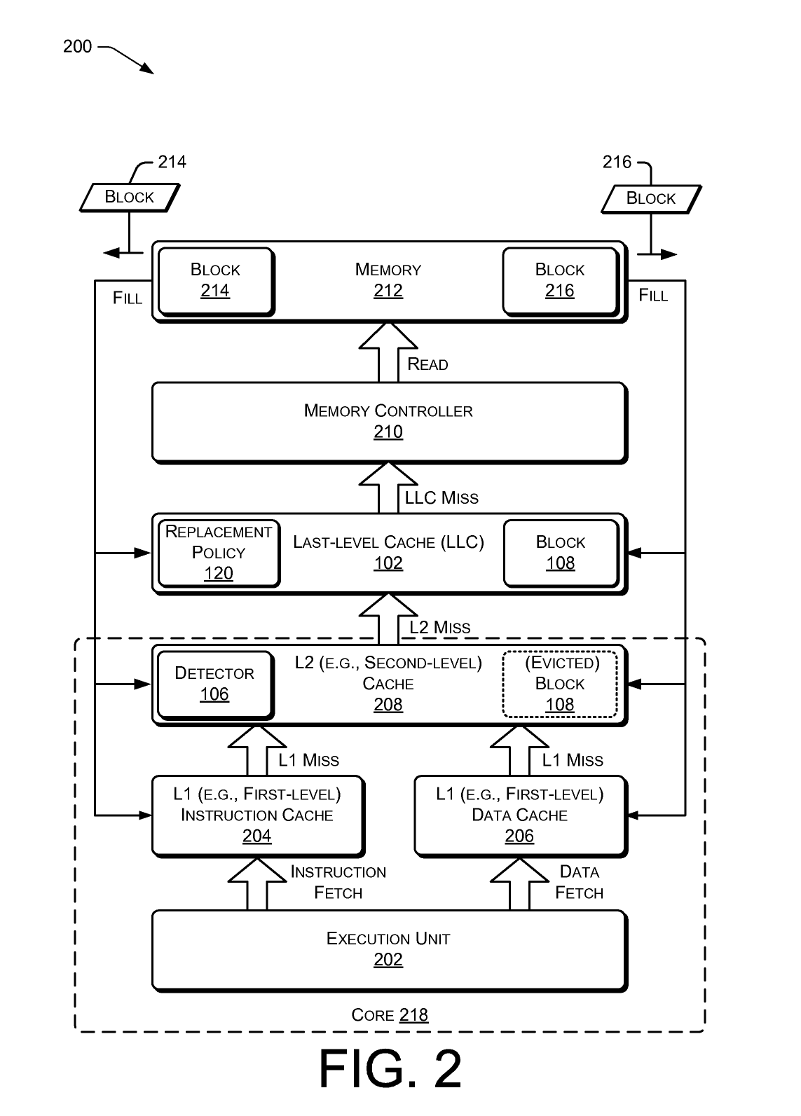

FIG. 2 illustrates an example framework 200 that includes a cache hierarchy according to some implementations. The framework 200 may be incorporated into a particular processor.

The framework 200 includes an execution unit 202, an L1 instruction cache 204, an L1 data cache 206, an L2 cache 208, the LLC 102, a memory controller 210, and a memory 212. The execution unit 202 may be a portion of a processor that is capable of executing instructions. In some implementations, a processor may have multiple cores, with each core having a processing unit and one or more caches.

The framework 200 illustrates a three-level cache hierarchy in which the L1 caches 204 and 206 are closest to the execution unit 202, the L2 cache 208 is farther from the execution unit 202 compared to the L1 caches 204 and 206, and the LLC 102 is the farthest from the execution unit 202.

In operation, the execution unit 202 may perform an instruction fetch after executing a current instruction. The instruction fetch may request a next instruction from the L1 instruction cache 204 for execution by the execution unit 202. If the next instruction is in the L1 instruction cache 204, an L1 hit may occur and the next instruction may be provided to the execution unit 202 from the L1 instructions cache 204. If the next instruction is not in the L1 instruction cache 204, an L1 miss may occur. The L1 instruction cache 204 may request the next instruction from the L2 cache 208.

If the next instruction is in the L2 cache 208, an L2 hit may occur and the next instruction may be provided to the L1 cache 204. If the next instruction is not in the L2 cache 208, an L2 miss may occur, and the L2 cache 208 may request the next instruction from the LLC 102.

If the next instruction is in the LLC 102, an LLC hit may occur and the next instruction may be provided to the L2 cache 208 and/or to the L1 instruction cache 204. If the next instruction is not in the LLC 102, an LLC miss may occur and the LLC 102 may request the next instruction from the memory controller 210. The memory controller 210 may read a block 214 that includes the next instruction and fill the L1 instruction cache 204 with the block 214. If the LLC 102 and the L2 cache 208 are inclusive of the L1 instruction cache 204, the memory controller 210 may fill the block 214 into the L1 instruction cache 204, the L2 cache 208, and the LLC 102. If the LLC 102 is inclusive of the L1 instruction cache 204 but the L2 cache 208 is exclusive of the L1 instruction cache 204, the memory controller 210 may fill the block 214 into the L1 instruction cache 204 and the LLC 102.

The next instruction may be fetched from the L1 instruction cache to enable the execution unit 202 to execute the next instruction. Execution of the next instruction may cause the execution unit 202 to perform a data fetch. For example, the next instruction may access particular data. The data fetch may request the particular data from the L1 data cache 206. If the particular data is in the L1 data cache 206, an L1 hit may occur and the particular data may be provided to the execution unit 202 from the L1 data cache 206. If the particular data is not in the L1 data cache 206, an L1 miss may occur. The L1 data cache 206 may request the particular data from the L2 cache 208.

If the particular data is in the L2 cache 208, an L2 hit may occur and the particular data may be provided to the L1 data cache 206. If the particular data is not in the L2 cache 208, an L2 miss may occur, and the L2 cache 208 may request the particular data from the LLC 102.

If the particular data is in the LLC 102, an LLC hit may occur and the particular data may be provided to the L2 cache 208 and/or to the L1 data cache 206. If the particular data is not in the LLC 102, an LLC miss may occur and the LLC 102 may request the particular data from the memory controller 210. The memory controller 210 may read a block 216 that includes the particular data and fill the L1 data cache 206 with the block 216. If the LLC 102 and the L2 cache 208 are inclusive of the L1 data cache 206, the memory controller 210 may fill the block 216 into the L1 data cache 206, the L2 cache 208, and the LLC 102. If the LLC 102 is inclusive of the L1 data cache 206 but the L2 cache 208 is exclusive of the L1 data cache 206, the memory controller 210 may fill the block 216 into the L1 data cache 206 and the LLC 102.

In some implementations, a core 218 may include the execution unit 202 and one or more of the caches 102, 204, 206, or 208. For example, in FIG. 2, the core 218 includes the caches 204, 206, and 208 but excludes the LLC 102. In this example, the LLC 102 may be shared with other cores. As another example, if the core 218 includes the LLC 102, the LLC 102 may be private to the core 218. Whether the LLC 102 is private to the core 218 or shared with other cores may be unrelated to whether the LLC 102 is inclusive or exclusive of other caches, such as the caches 204, 206, or 208.

Thus, the L2 cache 208 may determine to evict the block 108 based on attributes of the block 108, such as how frequently and/or how often the block 108 has been accessed in the L2 cache 208. After the block 108 is evicted from the L2 cache 208, the L2 cache 208 may notify the detector 106 of the evicted block 108. In response, the detector 106 may determine whether the block 108 is a candidate for eviction from the LLC 102. If the detector 106 determines that the block 108 is a candidate for eviction, the detector 106 may recommend the block 108 as a candidate for eviction to the LLC 102. The LLC 102 may include the block 108 in a set of eviction candidates (e.g., the eviction candidates 122 of FIG. 1). The replacement policy 122 may evict the block 108 from the LLC 102 to enable the LLC 102 to be filled with another block from the memory 212.

### Categorizing Blocks

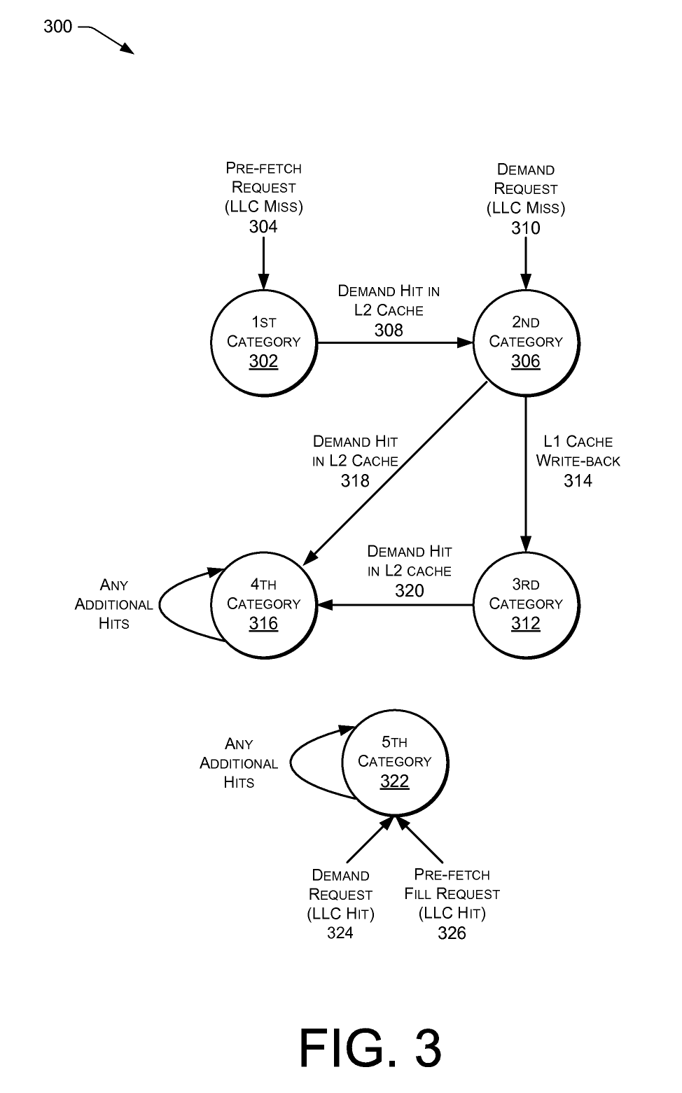

FIG. 3 illustrates an example framework 300 that includes state transitions for categorized blocks in a lower-level cache according to some implementations. The framework 300 illustrates how blocks in a cache may be categorized and how the blocks may transition from one category to another category. In FIG. 3, a scheme for categorizing blocks is illustrated using five categories. However, other categorization schemes may use greater than five or less than five categories.

Blocks (e.g., blocks of memory) located in an L2 cache (e.g., the L2 cache 208) may be categorized into one of multiple categories. When a particular block is evicted from the L2 cache, the category associated with the particular block may be provided to a detector (e.g., the detector 106). The detector may determine whether the particular block is a candidate for eviction from the last-level cache (e.g., the LLC 102) based at least partially on the category associated the particular block.

A first category 302 may be associated with a block evicted from an L2 cache if the block was filled into the L2 cache by a prefetch request 304 that missed in the LLC and the block did not experience a single demand hit during its residency in the L2 cache. For example, the block may have been filled into the L2 cache by either a premature or an incorrect prefetch request.

A second category 306 may be associated with a block evicted from an L2 cache if the evicted L2 cache block was filled into the L2 cache by a demand request 308 that missed in the LLC, the block has not experienced a single demand hit during its residency in the L2 cache, and at the time of the eviction the block in the L2 cache was unmodified. In addition, a second category may be associated with a block evicted from an L2 cache if a prefetched block experiences exactly one demand hit 310 during its residency in the L2 cache. Thus, the second category may be associated with a block filled into the L2 cache that has exactly one demand use (including the fill) and is evicted in a clean (e.g., unmodified) state from the L2 cache.

A third category 312 may be associated with a block evicted from an L2 cache if the evicted L2 cache block was filled into the L2 cache by the demand request 308 that missed in the LLC, the block has not experienced a single demand hit during its residency in the L2 cache, and at the time of the eviction, the block in the L2 cache had been modified. Thus, the third category may be similar to the second category except that when the block is evicted from the L2 cache the block is in a modified state rather than in a clean state. Thus, a block associated with the third category was filled into the L1 cache, the block was modified, and the block was evicted and written back to the L2 cache by an L1 cache write-back 314. If the L2 cache is exclusive of the L1 cache, a writeback from the L1 cache may miss in the L2 cache. In such cases, the block may be associated with the third category and the writeback may be forwarded to the LLC. Once evicted from the L1 cache, more than forty-percent of blocks in the third category may have very large next-use distances that are beyond the reach of the LLC, e.g., the block may not be accessed in the LLC in the near future and may thus be a candidate for eviction from the LLC.

A fourth category 316 may be associated with a block (i) if the evicted L2 cache block was filled into the L2 cache by the demand request 308 that missed in the LLC and experienced a demand hit in the L2 cache (e.g., the demand hit in L2 318) or (ii) if the evicted L2 cache block was filled into the L2 cache by the prefetch request 304 that missed in the LLC and experienced at least two demand hits (e.g., the demand hit in L2 310 and the demand hit in L2 318) in the L2 cache. For example, a block that was filled into the L2 cache as a result of the prefetch request 304 and experienced (i) the demand hit in the L2 cache 310 (e.g., thereby transitioning the block to the second category 306) and (ii) the demand hit in the L2 cache 318 may be associated with the fourth category 316. As another example, a block that was filled into the L2 cache as a result of the demand request 308 and experienced a demand hit in the L2 cache 318 may be associated with the fourth category 316. Thus, the fourth category 316 may be associated with a block that has experienced at least two demand uses (including the fill) during its residency in the L2 cache. A block associated with the fourth category 316 may continue to remain associated with the fourth category 316 if the block experiences any additional demand hits. A block associated with the fourth category 316 may have a reuse cluster that falls within the reach of the L2 cache.

A fifth category 322 may be associated with a block if the evicted L2 cache block was filled into the L2 cache in response to a demand request 324 that hit in the LLC or a prefetch fill request 326 that hit in the LLC. A block associated with the fifth category 322 may continue to remain associated with the fourth category 316 if the block experiences any additional demand hits. A block associated with the fifth category may have a reuse cluster within the reach of the LLC.

Table 1 summarizes the categorization scheme illustrated in FIG. 3.

TABLE 1
Example Categories

| | 1^{st} | 2^{nd} | 3^{rd} | 4^{th} | 5^{th} |
|---|---|---|---|---|---|
| Attribute | Category | Category | Category | Category | Category |
| Request that | Prefetch | Demand | Demand | Demand | Demand |
| filled L2 | | or | or | or | or |
| | | Prefetch | Prefetch | Prefetch | Prefetch |
| LLC | Miss | Miss | Miss | Miss | Hit |
| hit/miss | | | | | |
| L2 demand | 0 | 1 | 1 | 2 or more | N/A |
| uses | | | | | |
| L2 eviction | E/S | E/S | M | N/A | N/A |
| state | | | | | |

In Table 1, ‘E’ stands for an Exclusive state in which the core holding the block has full and exclusive rights to read and modify the block, ‘S’ stands for a Shared state in which two or more cores may freely read but not write (if the core needs to write to the block the core may trigger coherence actions), ‘M’ stands for Modified, and N/A stands for Not Applicable. In some implementations, one or more additional categories may be added based on the L2 eviction state. For example, a first additional category may be used for the “E” state and a second additional category may be used for the “S” state.

While the categorization scheme illustrated in FIG. 3 uses five categories, other categorization schemes may use greater than five categories or less than five categories. For example, some of the categories may be combined in a scheme that uses fewer than five categories. To illustrate, in a four category scheme, the second category 306 may be combined with either the fourth category 316 or the first category 302. As another example, one or more categories may be divided into additional categories in a scheme that uses greater than five categories. To illustrate, the fourth category 316 may be expanded into one or more additional categories that are based on how many demand hits experienced in the L2 by the block.

In some implementations, the categorization scheme may be based on reuse distances identified from a cache usage pattern for one or more caches. For example, a cache usage pattern may indicate that (i) at least some of the blocks in the third category may be within reach of an L2 cache, (ii) at least some of the blocks in the first, second, third, and fourth categories that are out of the reach of the L2 cache may be within the reach of the LLC, and (iii) some of the blocks in the first, second, and third categories may be out of the reach of both the L2 cache and the LLC. Blocks evicted from the L2 cache that are out of the reach of the LLC may be candidates for eviction from the LLC.

Thus, a categorization scheme may be used to categorize a block based on various attributes associated with the block, such as a request that caused the block to be filled into the L2 cache, how many demand uses the block has experienced in the L2 cache, whether or not the blocks was modified, other attributes associated with the block, or any combination thereof. When a block is evicted from the L2 cache, the detector may be provided with a category associated with the block. The detector may determine whether the block evicted from the L2 cache is a candidate for eviction from the LLC based at least in part on the category of the block.

### Example Processes

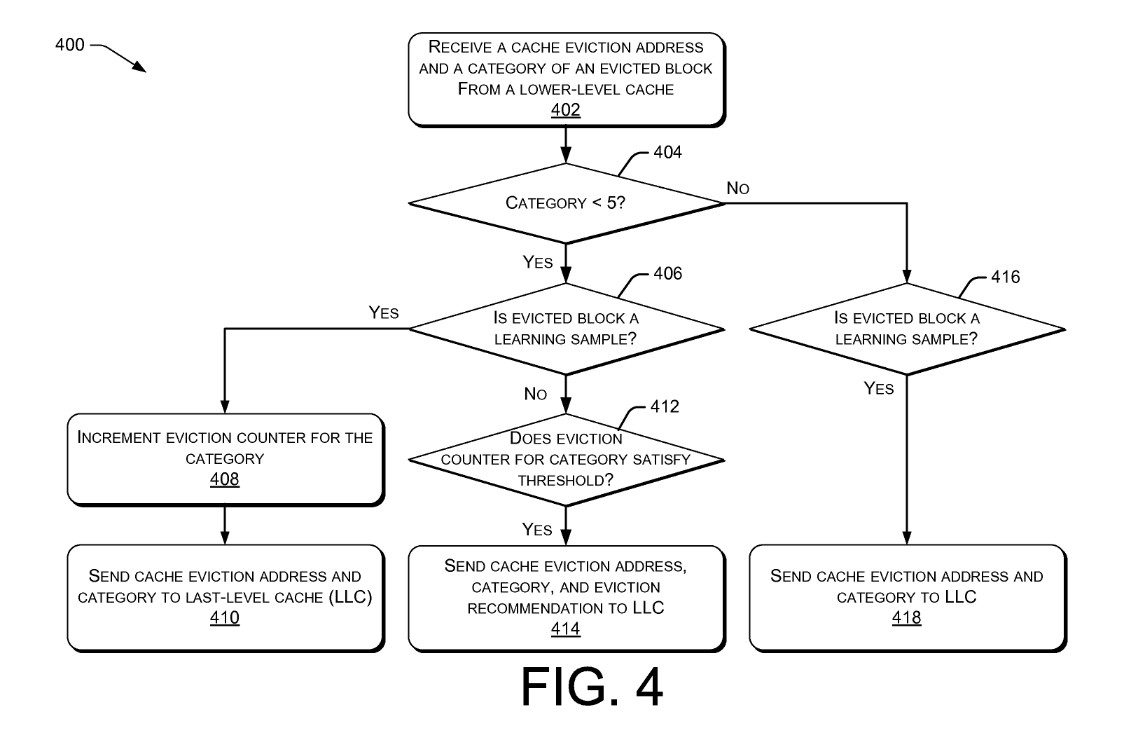

In the flow diagrams of FIGS. 4, 5, 6, 7, and 8, each block represents one or more operations that can be implemented in hardware, firmware, software, or a combination thereof. The processes described in FIGS. 4, 5, 6, 7, and 8 may be performed by the detector 106. In the context of hardware, the blocks may represent hardware-based logic that is executable by the processor to perform the recited operations. In the context of software or firmware, the blocks may represent computer-executable instructions that, when executed by the processor, cause the processor to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 400, 500, 600, 700, and 800 are described with reference to one or more of the frameworks 100, 200, and 300 described above, although other models, frameworks, systems and environments may be used to implement these processes.

FIG. 4 illustrates a flow diagram of an example process 400 that includes sending an eviction recommendation to a last-level cache based on eviction information received from a lower-level cache according to some implementations. The process 400 may be performed by the detector 106. The detector 106 may be located in the L2 cache 208 or in the LLC 102.

The categories illustrated in FIG. 3 may, in mathematical terms, be expressed as C5⊂C1∪C2∪C3∪C4, where C1 is the first category 302, C2 is the second category 306, C3 is the third category 312, C4 is the fourth category 316, and C5 is the fifth category 322. In other words, a portion of the blocks from C1∪C2∪C3∪C4 that experience an LLC hit may gain membership in to the fifth category 322. The remaining portion of the blocks (e.g., (C1∪C2∪C3∪C4) \ C5) may eventually be evicted from the LLC 102 without experiencing any LLC hits. Therefore, when a block is evicted from the L2 cache 208, the detector 106 may identify blocks from C1∪C2∪C3∪C4 that are unlikely to experience an LLC hit and are therefore candidates for eviction from the LLC 102.

After evicting a block from the L2 cache 208, the L2 cache 208 may query the L1 data cache 206 to determine whether the evicted block was modified in the L1 data cache 206. If the query hits in the L1 data cache, the L1 data cache 206 may retain the block (e.g., if the L2 cache 208 is exclusive of the L1 data cache 206). However, if a block that is evicted from the L2 cache 208 does not hit in the L1 data cache 206, the notification 108 may be sent to the detector 106 to determine whether the block is a candidate for eviction from the LLC 102.

At 402, a cache eviction address and a category of a block that was evicted from a lower-level cache may be received. For example, the detector 106 may receive the notification 110 from the lower-level cache 104. The notification may include a cache eviction address of the block and a category associated with the block.

At 404, a determination is made whether the block is associated with one of the first, second, third, or fourth category. If, at 404, the answer is no (e.g., the block is associated with the fifth category) then the block is considered “live” and is not considered as a candidate for eviction and the process proceeds to 416.

If, at 404, the answer is “yes” (e.g., the block is associated with one of the first, second, third, or fourth category), then the detector 106 may update one or more of the eviction statistics 118. For example, the detector 106 may maintain two counters, such as a dead eviction counter (Dⁿ for category n) and a live eviction counter (Lⁿ for category n) for each of the first, second, third, and fourth categories 302, 306, 312, and 316. In some implementations, the counters may use saturation arithmetic, in which addition and subtraction operations may be limited to a fixed range between a minimum and maximum value. In saturation arithmetic, if the result of an operation is greater than the maximum it may be set (“clamped”) to the maximum, while if it is below the minimum it may be clamped to the minimum.

A block that is evicted from the L2 cache 208 may be classified as “live” if the block experiences at least one hit in the LLC 102 between the time it is evicted from the L2 cache 208 and the time it is evicted from the LLC 102. Otherwise, e.g., if a block experiences no hits in the LLC 102 between the time it is evicted from the L2 cache 208 and the time it is evicted from the LLC 102, the block is considered “dead”. To maintain the eviction statistics 118, the detector 106 may dedicate some blocks as learning samples. For example, sixteen learning sample sets from each 1024 set of blocks in the LLC 102 may be designated as learning samples. The learning samples may be evicted using a not recently used (NRU) policy to provide baseline statistics for identifying blocks that are candidates for eviction from the LLC 102. When the detector 106 receives the notification of evicted block 108 from the L2 cache 208 including the category associated with the evicted block, the detector 106 may determine an LLC set index associated with the block.

If, at 404, the answer is “yes” (e.g., the block is associated with one of the first, second, third, or fourth category), a determination is made, at 406 if the evicted block is a learning sample. If, at 406, the answer is “yes” (e.g., the block maps to one of the learning samples), then, at 408, the corresponding eviction counter (e.g., Dⁿ for category n) may be incremented by one using saturation arithmetic.

At 410, the cache eviction address and the category associated with the block may be sent to the LLC 102.

If, at 406, the answer is “no” (e.g., the evicted block is not a learning sample) a determination is made, at 412, whether an eviction counter associated with the block satisfies a threshold.

If, at 412, the answer is “yes” (e.g., the eviction counter for the category associated with the evicted block satisfies the threshold), then the cache eviction address, the category, and an eviction recommendation associated with the block may be sent to an LLC (e.g., the LLC 102), at 414. For example, the recommendation 120 may indicate that the block evicted from the lower-level cache 104 is a candidate for eviction from the LLC 102. In response to receiving the recommendation 120, the LLC 102 may place the block identified by the recommendation 120 in the set of eviction candidates 118. To illustrate, for a particular category n and a multiplier X, if Dⁿ>(X*Lⁿ), then the block may be considered “dead” and may therefore be a potential candidate for eviction from the LLC. This formula identifies categories that have a hit rate in the LLC 102 that is bounded above by 1/(1+X). The average hit rate in the LLC 102 for a class n may be expressed as Lⁿ/(Dⁿ+Lⁿ). In some implementations, the multiplier X may be set to a particular number. For example, setting the multiplier X to eight may result in a hit-rate bound of 11.1%. In some implementations, the value of X may be static whereas in other implementations the value of X may vary among the multiple categories, based on an execution phase associated with the block, based on other factors, or any combination thereof. In some implementations, the multiplier X may be different for at least two of the categories. For example, a multiple Xⁿ may be associated with each category n.

If, at 404, the answer is “no” (e.g., the fifth category 322 is associated with the block), then a determination is made whether the evicted block is one of the learning samples, at 416.

If, at 416, the answer is “yes” (e.g., the evicted block is a learning sample) then the cache eviction address and the category may be sent to the LLC 102, at 418.

Thus, when the detector 106 receives an address and a category of a block that was evicted from a lower-level cache (e.g., the L2 208), the detector 106 may determine whether the block is a candidate for eviction from the LLC 102. For example, if a first, second, third, or fourth category is associated with the block, the block is not a learning sample, and the dead counter for the category satisfies a threshold, the detector 106 may send the recommendation 120 to the LLC 102 indicating that the block may be a candidate for eviction. To illustrate, for a particular category, if the number of dead blocks is greater than eight times the number of live blocks, the detector 106 may recommend the block for eviction from the LLC 102.

In response to receiving the recommendation 120 from the detector 106, the LLC 102 may act based on whether or not the address 112 is associated with a block that is one of the learning samples of the LLC 102. If the recommendation 120 identifies a block that maps to a learning sample, the LLC 102 may store the three bits that identify the category of the block and clear a bit position corresponding to an evicting core in a sharer bitvector of the block to save a future back-invalidation.

If the recommendation 120 identifies a block that does not map to a learning sample, the LLC 102 may clear a bit position corresponding to an evicting core in a coherence bitvector of the block. The LLC 102 may reset an NRU age bit for the block, thereby identifying the block as a candidate for eviction.

In an implementation that uses five categories, the learning sample set of the LLC 102 may use three bits to identify a category of a block that is evicted from the L2 cache. The three bits may be associated with a block when the block is one of the learning samples. These bits may be implemented using a separate random access memory (RAM) that is accessed through an index context-addressable memory (CAM) that identifies accesses to the learning samples. The L2 cache 208 may use two state bits (e.g., a first state bit and a second state bit) and a bit that indicates whether or not the block has been modified to encode the category associated with each block. Thus, three bits that are available in each block may be used to encode the category of each block, as illustrated in Table 2. In implementations with a different number of categories, the number of bits may be adjusted accordingly. For example, if there are less than five categories, fewer bits may be used. If there are greater than five categories, additional bits may be used.

TABLE 2
Encoding a Category in an L2 Cache

| Modified State Bit | 1st State Bit | 2nd State Bit | Category |
|---|---|---|---|
| N/A | 0 | 0 | 1st Category |
| 0 | 0 | 1 | 2nd Category |
| 1 | 0 | 1 | 3rd category |
| N/A | 1 | 0 | 4th Category |
| N/A | 1 | 1 | 5th Category |

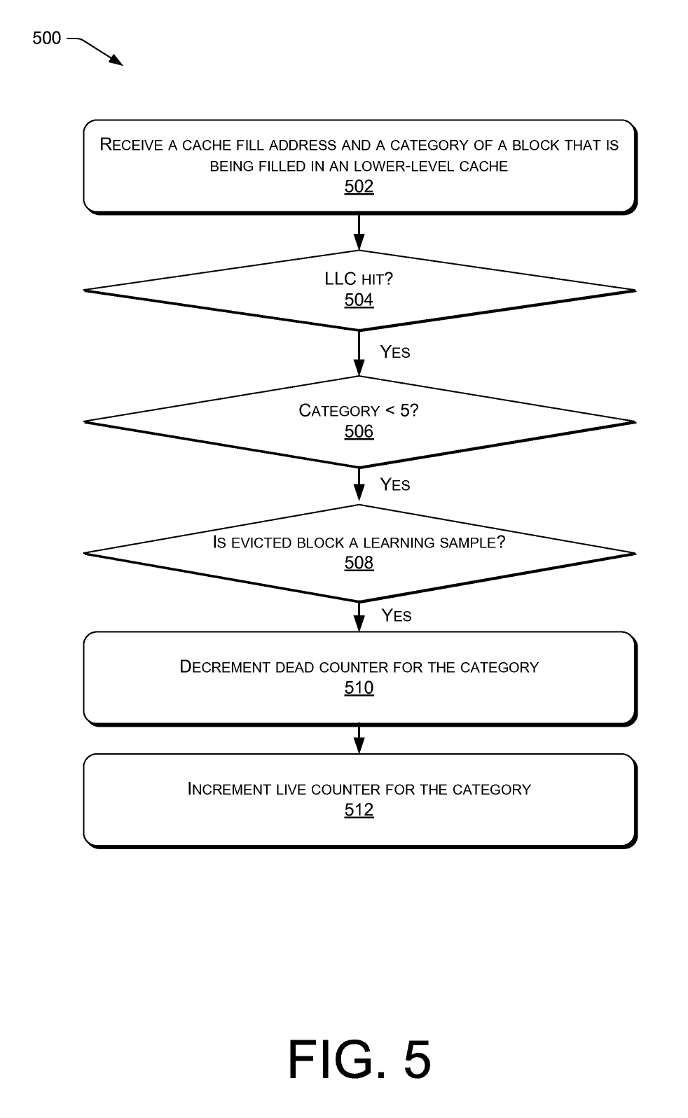

FIG. 5 illustrates a flow diagram of an example process 500 that includes updating counters associated with categories of blocks based on cache fill information received from a lower-level cache according to some implementations. For example, the process 500 may be performed by the detector 106.

At 502, when a block is being filled into a lower-level cache (e.g., the L2 cache 208), a cache fill address and a category associated with the block may be received by the detector 106.

At 504, if a determination is made that the block is being filled in response to a hit in the LLC 102 and, at 506, if a determination is made that the first, second, third, or fourth category are associated with the block being filled, and at 508, if a determination is made that the filled block is a learning sample, then the dead counter (e.g., Dⁿ) associated with the category is decremented, at 510, and the live counter (Lⁿ) associated with the category is incremented, at 512. In some implementations, the dead counter may be decremented and/or the live counter may be incremented using saturation arithmetic.

Thus, when a block that is one of the learning samples experiences a hit in the LLC 102, the three bits associated with the requested block may be sent to the L2 cache 208 to identify the old (e.g., prior to the hit in the LLC 102) category of the block. After experiencing the hit in the LLC 102, the block may be associated with the fifth category 322. The LLC 102 may send an indicator (e.g., one bit) indicating whether a hit occurred or a miss occurred in the LLC 102. A fill message may be sent to the detector 106. If a hit occurred in the LLC 102, the block to be filled in the L2 cache 208 is an LLC learning sample, and the first, second, third, or fourth category is associated with the block, then Lⁿ may be incremented to take into account the LLC hit and Dⁿ may be decremented to nullify an earlier increment when the block was previously evicted from the L2 cache 208. In some implementations, the counters Dⁿ and Lⁿ may be halved for every pre-determined (e.g., 128, 256, 512 and the like) number of evictions from the L2 cache 208 that are LLC learning samples.

Thus, the values accumulated in the counters Dⁿ and Lⁿ counters may be used by the detector 106 to flag blocks evicted from the L2 cache 208 that appear to be “dead” and may be candidates for eviction from the LLC 102. If the average LLC hit rate associated with a particular category falls below the threshold (e.g., 11.1% when the multiplier is set to eight) during a certain phase of execution, then a block belonging to the particular category may be marked for eviction from the LLC 102 after the block is evicted from the L2 cache 208.

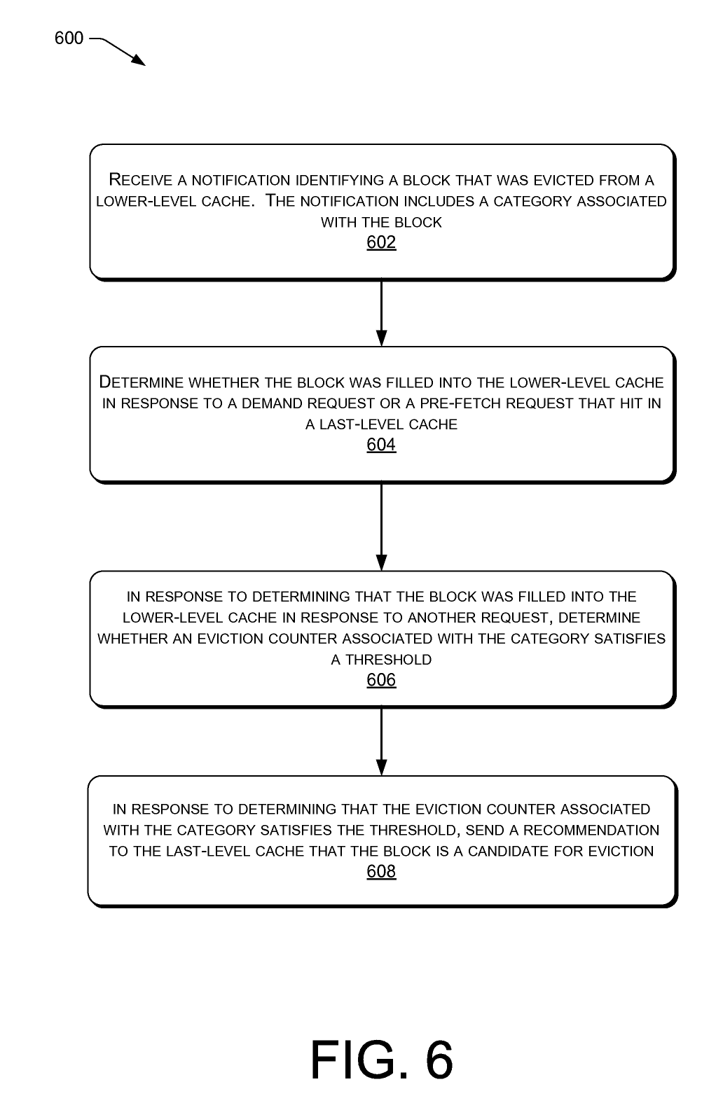

FIG. 6 illustrates a flow diagram of an example process 600 that includes sending an indication to a last-level cache that a block is a candidate for eviction according to some implementations. For example, the detector 106 may perform the process 600.

At 602, a notification identifying a block evicted from a lower-level cache may be received. The notification may include a category associated with the block. For example, in the FIG. 1, the detector 106 may receive the notification 110 indicating that the block 108 was evicted from the lower-level cache 104.

At 604, a determination is made whether the block was filled into the lower-level cache in response to a demand request or a prefetch request that hit in a last-level cache. For example, in FIG. 1, the detector 106 may determine whether the category 114 associated with the block 108 is associated with the fifth category 322.

At 606, in response to determining that the block was filled into the lower-level cache in response to another request, a determination is made whether an eviction counter associated with the category satisfies a threshold. For example, in response to determining that the category 114 of the block 108 is one of the first, second, third, or fourth categories 302, 306, 312, or 316, the detector 106 may determine whether Dⁿ>(8*Lⁿ) for the category 114 associated with the block 108.

At 608, in response to determining that the eviction counter associated with the category satisfies the threshold, a recommendation may be sent to the LLC that the block is candidate for eviction. For example, in FIG. 1, the detector 106 may send the recommendation 120 indicating that the block 108 is a candidate for eviction from the LLC 102.

Thus, a detector may determine whether a block evicted from a lower-level cache is a candidate for eviction from an LLC based at least in part on a category associated with the block, eviction statistics associated with the category, other attributes of the block, or any combination thereof. The LLC may use the information provided by the detector to update a set of eviction candidates to include the block evicted from the lower-level cache. In this way, the LLC may identify candidates for eviction that the LLC would not otherwise identify.

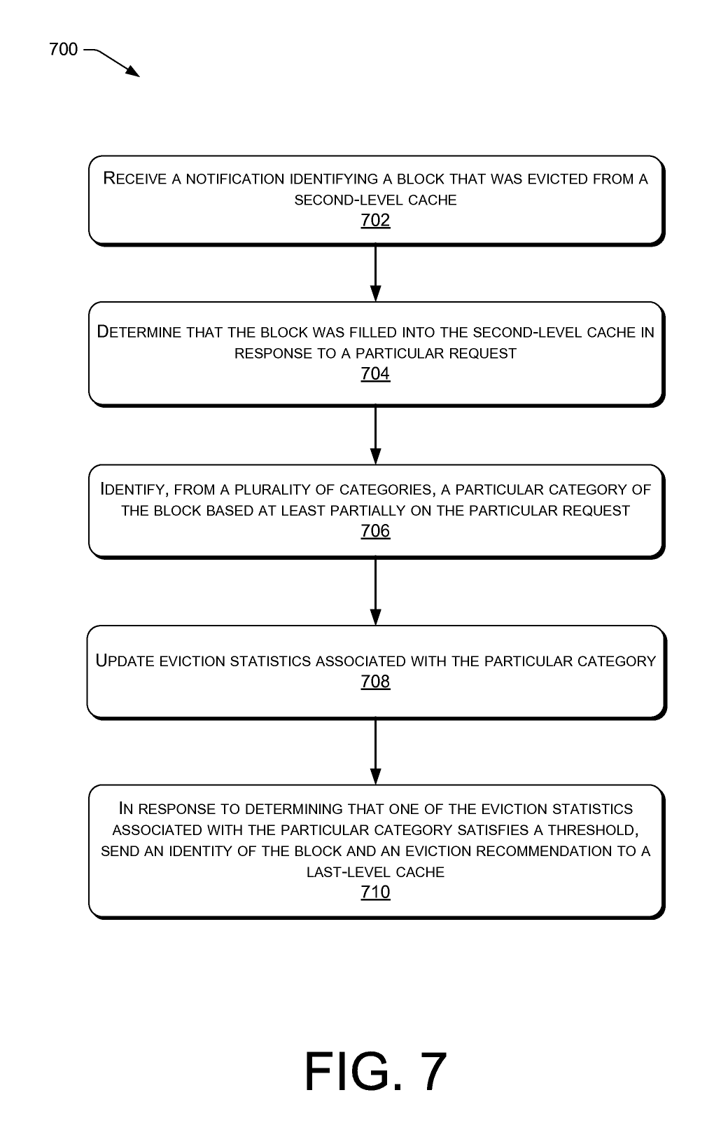

FIG. 7 illustrates a flow diagram of an example process 700 that includes sending an eviction recommendation to a last-level cache according to some implementations. For example, the detector 106 may perform the process 700.

At 702, a notification identifying a block evicted from a second-level cache may be received. For example, in the FIG. 2, the detector 106 may receive a notification indicating that the block 108 was evicted from the L2 cache 206.

At 704, a determination is made whether the block was filled into the second-level cache in response to a particular request. For example, the detector 106 may determine whether the block was filled in response to a demand request that hit in the LLC or in response to a prefetch fill request that hit in the LLC.

At 706, a particular category of the block may be identified from a plurality of categories based at least partially on the particular request. For example, the detector 106 may determine whether the block is associated with the first category 302, the second category 306, the third category 312, the fourth category 316, or the fifth category 322.

At 708, eviction statistics associated with the particular category may be updated. For example, if the block is a learning sample, the dead counter associated with the particular category of the block may be incremented (e.g., block 408 of FIG. 4). To illustrate, in FIG. 1, the detector 106 may update the eviction statistics 118 in response to determining that the block 108 is a learning sample.

At 710, in response to determining that one of the eviction statistics associated with the particular category satisfies a threshold (e.g., block 412 of FIG. 4), an identity of the block and an eviction recommendation may be sent to a last-level cache. For example, in FIG. 1, the detector 106 may send the recommendation 120 to the LLC 102 in response to determining that the eviction statistics 118 satisfy a threshold (e.g., Dⁿ>(8*Lⁿ) where n is the particular category).

Thus, a detector may determine whether a block evicted from a lower-level cache is a candidate for eviction from an LLC based at least in part on a category associated with the block, eviction statistics associated with the category, other attributes of the block, or any combination thereof. The LLC may use the information provided by the detector to update a set of eviction candidates to include the block evicted from the lower-level cache. Using information associated with blocks evicted from a lower-level cache may enable the LLC to identify more eviction candidates and/or identify them faster than without the information.

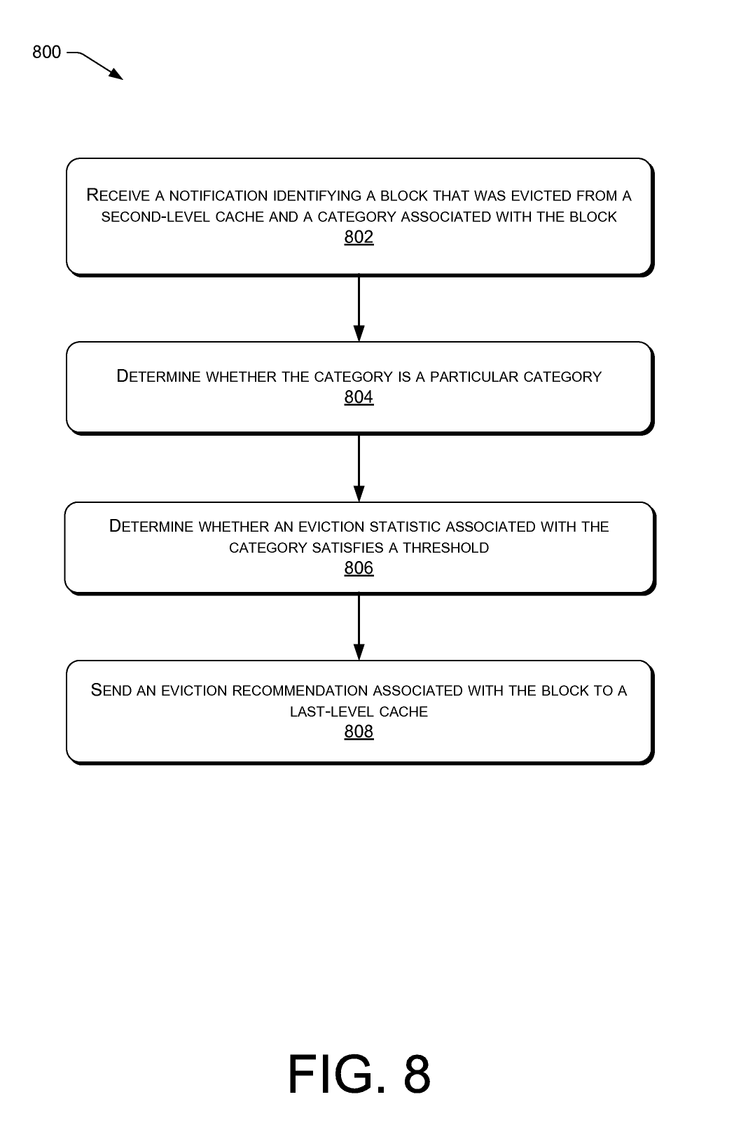

FIG. 8 illustrates a flow diagram of an example process 800 that includes sending an eviction recommendation associated with a block to a last-level cache according to some implementations.

At 802, a notification identifying a block that was evicted from a second-level cache may be received. The notification may include a category associated with the block. For example, in the FIG. 1, the detector 106 may receive the notification 110 indicating that the block 108 was evicted from the lower-level cache 104.

At 804, a determination is made whether the category is a particular category. For example, in FIG. 1, the detector 106 may determine whether the category 114 associated with the block 108 is the fifth category 322.

At 806, a determination is made whether an eviction counter associated with the category satisfies a threshold. For example, in response to determining that the category 114 of the block 108 is one of the first, second, third, or fourth categories 302, 306, 312, or 316, the detector 106 may determine whether Dⁿ>(8*Lⁿ) for the category 114 associated with the block 108.

At 808, an eviction recommendation associated with the block may be sent to an LLC. For example, in FIG. 1, the detector 106 may send the recommendation 120 to the LLC 102 indicating that the block 108 is a candidate for eviction.

Thus, a detector may be notified when a block is evicted from an L2 cache and determine whether the block is a candidate for eviction from an LLC that is inclusive of the L2 cache. In response to determining that the block is a candidate for eviction, the detector may send a recommendation to the LLC that the block may be evicted. The detector may thus identify a subset of the blocks evicted from the L2 cache as candidates for eviction from an LLC.

The detector 106 may be implemented in a single core or a multiple-core processor. In a multiple-core processor, each core may have an associated second-level (e.g., L2) cache.

In a multiple-core processor, if the detector 106 is to be located in an LLC, a dead counter Dⁿ and a live counter Lⁿ (e.g., for each category n, where n is the number of categories) may be maintained for each thread to enable eviction recommendations to be sent for each independent thread. When a particular core evicts a block from an L2 cache that is associated with the particular core, an identity of the core may be sent to the detector 106 along with an eviction address of the block.

In a multiple-core processor, if the detector 106 is to be located in an L2 cache rather than in the LLC, the L2 cache associated with each core of the processor may include a detector (e.g., similar to the detector 106). In such an implementation, the learning samples in the LLC may be shared across multiple threads.

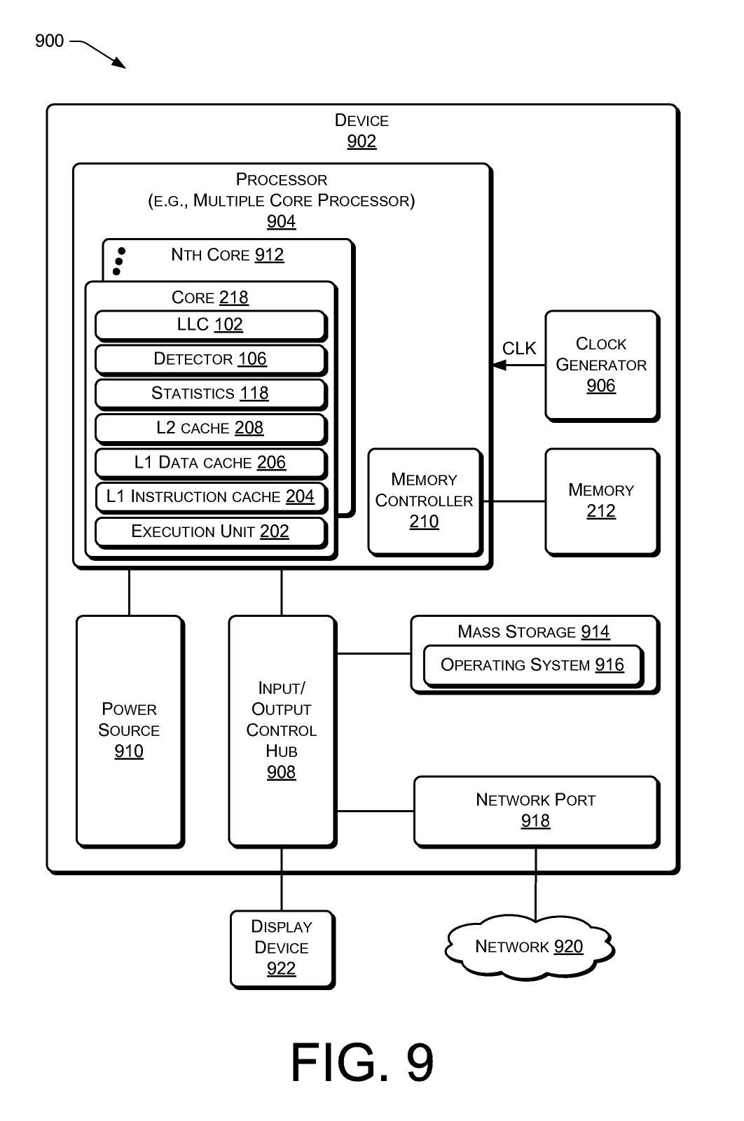

FIG. 9 illustrates an example framework 900 of a device that includes a detector for identifying eviction candidates according to some implementations. The framework 900 includes a device 902, such as a desktop computing device, a laptop computing device, tablet computing device, netbook computing device, wireless computing device, and the like.

The device 902 may include one or more processors, such as a processor 904, a clock generator 906, the memory 212 (e.g., random access memory), an input/output control hub 908, and a power source 910 (e.g., a battery or a power supply). The processor 904 may include multiple cores, such as the core 218 and one or more additional cores, up to and including an N^{th} core 912, where N is two or more. The processor 904 may include the memory controller 210 to enable access (e.g., reading from or writing) to the memory 212.

At least one of the N cores 218 and 912 may include the execution unit 202, the L1 instruction cache 204, the L1 data cache 206, and the L2 cache 208 of FIG. 2, and the statistics 118, the detector 106, and the LLC 102 of FIG. 1. The detector 106 may be located in the L2 cache 208 or the LLC 102. The detector 106 may be adapted to receive a notification identifying a block evicted from a lower-level cache, such as the caches 204, 206, or 208, determine whether the block is candidate for eviction from the LLC 102, and notify the LLC 102 when the block is a candidate for eviction.

The clock generator 906 may generate a clock signal that is the basis for an operating frequency of one or more of the N cores 218 and 912 of the processor 904. For example, one or more of the N cores 218 and 912 may operate at a multiple of the clock signal generated by the clock generator 906.

The input/output control hub may be coupled to a mass storage 914. The mass storage 914 may include one or more non-volatile storage devices, such as disk drives, solid state drives, and the like. An operating system 916 may be stored in the mass storage 914.

The input/output control hub may be coupled to a network port 918. The network port 918 may enable the device 902 to communicate with other devices via a network 920. The network 920 may include multiple networks, such as wireline networks (e.g., public switched telephone network and the like), wireless networks (e.g., 802.11, code division multiple access (CDMA), global system for mobile (GSM), Long term Evolution (LTE) and the like), other types of communication networks, or any combination thereof. The input/output control hub may be coupled to a display device 922 that is capable of display text, graphics, and the like.

As described herein, the processor 904 may include multiple computing units or multiple cores. The processor 904 can be implemented as one or more microprocessors, microcomputers, microcontrollers, digital signal processors, central processing units, state machines, logic circuitries, and/or any devices that manipulate signals based on operational instructions. Among other capabilities, the processor 904 can be configured to fetch and execute computer-readable instructions stored in the memory 212 or other computer-readable media.

The memory 212 an example of computer storage media for storing instructions which are executed by the processor 904 to perform the various functions described above. The memory 212 may generally include both volatile memory and non-volatile memory (e.g., RAM, ROM, or the like). The memory 212 may be referred to as memory or computer storage media herein, and may be a non-transitory media capable of storing computer-readable, processor-executable program instructions as computer program code that can be executed by the processor 904 as a particular machine configured for carrying out the operations and functions described in the implementations herein. The processor 904 may include modules and/or components for determining whether a block evicted from a lower-level cache is a candidate for eviction from a last-level cache according to the implementations herein.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

What is claimed is:

1. A processor comprising:
a detector including logic to:
receive a notification identifying a block evicted from a second-level cache;
identify, from a plurality of categories, a particular category of the block based on a particular request that caused the block to be filled into the second-level cache; and
send an identity of the block and an eviction recommendation to a last-level cache.

2. The processor of claim 1, the logic to update eviction statistics associated with the particular category before sending the identity of the block and the eviction recommendation to the last-level cache.

3. The processor of claim 2, the logic to determine the eviction recommendation based on the updated eviction statistics associated with the particular category.

4. The processor of claim 1, wherein the block is evicted from the last-level cache in response to the last-level cache receiving the eviction recommendation.

5. The processor of claim 1, the logic to:
determine whether the block is included in a set of learning samples; and
in response to determining that the block is included in the set of learning samples, increment a dead counter associated with the particular category of the block.

6. The processor of claim 5, the logic to:
in response to determining that the block is excluded from the set of learning samples, determine whether the dead counter associated with the particular category satisfies a threshold associated with the particular category;
send the identity of the block and the eviction recommendation to the last-level cache when the dead counter satisfies the threshold; and
increment the live counter associated with the particular category when the block is filled into the lower-level cache in response to a hit in the last-level cache.

7. A system that includes at least one processor comprising:
a detector located in a second-level cache or a last-level cache, the detector to:
receive a notification identifying a block that was evicted from a second-level cache and a particular category associated with the block;
determine whether an eviction statistic associated with the particular category satisfies a threshold; and
in response to determining that the eviction statistic associated with the particular category satisfies the threshold, send an eviction recommendation associated with the block to the last-level cache.

8. The system of claim 7, wherein:
the particular category comprises a first category; and
the first category is associated with the block in response to determining that the block has experienced zero hits in the second-level cache.

9. The system of claim 7, wherein:
the particular category comprises a second category; and
the second category is associated with the block in response to determining that the block has experienced a single hit in the second-level cache and the block is unmodified.

10. The system of claim 7, wherein:
the particular category comprises a third category; and
the third category is associated with the block in response to determining that the block has experienced one hit in the second-level cache and the block has been modified.

11. The system of claim 7, wherein:
the particular category comprises a fourth category; and
the fourth category is associated with the block in response to determining that the block has experienced two or more hits in the second-level cache.

12. The system of claim 7, wherein:
the particular category comprises a fifth category; and
the fifth category is associated with the block in response to determining that the block was filled into the second-level cache in response to a hit in the last-level cache.

13. A method comprising:
receiving a notification identifying a block that was evicted from a lower-level cache of a processor, the notification including a category associated with the block; determining, from the notification, whether a statistic associated with the category satisfies a threshold; and
in response to determining that the statistic associated with the category satisfies the threshold, sending a recommendation to a last-level cache that the block is a candidate for eviction.

14. The method of claim 13, wherein:
the category associated with the block comprises a first category; and
the first category is associated with the block in response to determining that the block was filled into the lower-level cache by a prefetch request that missed in the last-level cache and the block did not experience a demand hit while residing in the lower-level cache.

15. The method of claim 13, wherein:
the category associated with the block comprises a second category; and
the second category is associated with the block in response to determining that the block was filled into the lower-level cache by a demand request that missed in the last-level cache, the block experienced zero demand hits while residing in the lower-level cache, and the block was unmodified when it was evicted from the lower-level cache.

16. The method of claim 13, wherein:
the category associated with the block comprises a second category; and
the second category is associated with the block in response to determining that the block was filled into the lower-level cache by a prefetch request that missed in the last-level cache and the block experienced a single demand hit while residing in the lower-level cache.

17. The method of claim 13, wherein:
the category associated with the block comprises a third category; and
the third category is associated with the block in response to determining that the block was filled into the lower-level cache by a demand request that missed in the last-level cache, the block experienced zero demand hits while residing in the lower-level cache, and the block was modified prior to being evicted from the lower-level cache.

18. The method of claim 13, wherein:
the category associated with the block comprises a fourth category; and
the fourth category is associated with the block in response to determining that the block was filled into the lower-level cache by a demand request that missed in the last-level cache and the block has experienced at least one demand hit in the lower-level cache.

19. The method of claim 13, wherein:
the category associated with the block comprises a fourth category; and
the fourth category is associated with the block in response to determining that the block was filled into the lower-level cache by a prefetch request that missed in the last-level cache and the block has experienced a plurality of demand hits in the lower-level cache.

20. The method of claim 13, wherein:
the category associated with the block comprises a fifth category; and
the fifth category is associated with the block in response to determining that the block was filled into the lower-level cache in response to a demand request that hit in the last-level cache.

21. The method of claim 13, wherein:
the category associated with the block comprises a fifth category; and
the fifth category is associated with the block in response to determining that the block was filled into the lower-level cache in response to a prefetch request that hit in the last-level cache.
